(19) United States
(12) Patent Application Publication
(10) Pub. No.: US 2011/0024586 A1
(43) Pub. Date: Feb. 3, 2011

(54) Hanging Dispensing System

(76) Inventors: Andrew Dale Brinkdopke, Appleton, WI (US); Ryan Leslie Fulscher, Neenah, WI (US); Robert Samuel Schlaupitz, New London, WI (US)

Correspondence Address: KIMBERLY-CLARK WORLDWIDE, INC.;Tara Pohlkotte, 2300 Winchester Rd., NEENAH, WI, 54956, US

(21) Appl. No.: 12/569,336

(22) Filed: Sep. 29, 2009

Related U.S. Application Data
(60) Provisional application No. 61/229,977, filed on Jul. 30, 2009.

(51) Int. Cl. F16M 13/00; A47B 96/06

(52) U.S. Cl. 248/205.4; 248/323; 248/205.1; 248/304

(57) ABSTRACT

A material dispensing system for hanging from a support is disclosed. The material dispensing system may contain a hanging member that includes an arm and an extension member slidably mounted on the arm. The arm includes a proximal end and a distal end. The rotatable attachment is a pivot point for the hanging member to rotate under or into the material dispenser. The extension member includes a retaining element to engage a support structure or a spindle of the paper roll holder. The material dispenser may include a base defining a cavity to store the hanging member which is rotatable into the cavity for storage. The hanging member may also have a proximal end rotatably connected to the material dispenser, and a distal end including a retaining element, wherein the retaining element is rotatable through an angle of at least about 90 degrees.

Pursuant to 35 U.S.C. §120 and/or 35 U.S.C. 119(e), Applicants hereby claim priority from presently copending U.S. Provisional Application No. 61/229,977 entitled “Hanging Dispensing System” filed on Jul. 30, 2009, in the names of Andrew D. Brinkdopke et al.

### BACKGROUND

Increasingly, consumers are using wet wipe products in addition to dry bathroom tissue for personal hygiene in the bathroom. However, most toilet paper roll holders are designed only to hold a single roll of dry bathroom tissue. The existing toilet paper roll holders are not designed for supporting a wet wipes dispenser. This can reduce or hinder using wet wipes within the bathroom if they cannot otherwise be located close to the toilet for easy use.

Various devices have been configured to allow for an additional wet wipe dispenser to mount with the existing designs for toilet paper roll holders. These devices usually take one of two approaches. One approach is to replace the existing toilet paper spindle in the toilet paper roll holder with a custom dispenser that mounts within the existing spindle holes. The custom dispenser usually has provisions for holding a dry tissue roll and a compartment for dispensing wet wipes. A drawback to this approach is that often the custom designed dispenser is large and/or unsightly. Many people do not like the look of the custom dispensers in the bathroom. Furthermore, the custom dispensers can be expensive. People who are unsure that they will like or use the custom dispenser often will not try the product due to the higher initial cost.

A second approach is to hang the wet wipes dispenser from the existing toilet paper holder by hooking the dispenser to the spindle. A problem with this approach is that refilling the toilet paper roll holder with a new tissue roll is cumbersome since you also have to remove and replace a second dispenser each time the toilet paper roll needs changing. Many consumers do not wish to bother with this annoyance and avoid the wet wipe dispensers with hooks that attach to the spindle. A further problem with using hooks to hang the wet wipes dispenser from the toilet paper spindle is that the hooks are permanently attached to the wet wipes dispenser such that the dispenser can only be used by hanging it from the toilet paper spindle.

An additional approach is to hang the wet wipes dispenser from the existing toilet paper holder by hooking the dispenser to the support structures of the toilet roll holder. A problem with this approach is that the size and shapes of support structures are different, and therefore may be difficult to have a product that fits with a large variety of toilet paper holders.

Additionally, consumers who use wet wipes tend to be split between those desiring to place the wet wipes dispenser near the dry tissue roll and those preferring to place the wet wipes dispenser out of sight or hidden since they would feel embarrassed if other people knew they were using the product. As such, it is desirable that a wet wipes dispenser can be optionally located near the dry toilet paper roll, or suitable for using on flat surfaces instead of hanging, or convenient to hold in a user's hands and dispense the wet wipes.

In view of the above, a need exists for a dispenser that can be located or hung from numerous portions of a paper roll holder. A need also exists for a dispenser than can be used either in a hanging mode, or by placing on a flat surface.

### SUMMARY

A material dispensing system for hanging from a support having a material dispenser which includes at least one hanging member is disclosed.

The material dispensing system may contain a hanging member that includes an arm and an extension member slidably mounted on the arm. The arm includes a proximal end and a distal end, the proximal end having a rotatable attachment to the material dispenser. The rotatable attachment can be a pivot point for the hanging member to rotate under or into the material dispenser. The extension member includes a retaining element to engage a support structure or a spindle of a paper roll holder.

The material dispenser includes a base defining a cavity which the at least one hanging member is rotatable into the cavity for storage. The base may be an integral part of the material dispenser. The base may also be a separate piece removably attachable to the material dispenser.

The extension member may slide along the arm to provide an extended position or a retracted position. When the extension member is in the extended position the at least one hanging member defines an extended length. The extended length is at least 10 cm. When the extension member is in the retracted position the at least one hanging member defines a compact length. The compact length is desirably less than the width of the cavity.

The retaining element may define an aperture or may be selected from a loop, an adhesive and a hook. The retaining element may contain a bracing material on a support-facing side of the retaining element, the bracing material comprising a thermoplastic elastomer. For example, the retaining element defines an aperture and comprises a bracing material extending toward the aperture. Then a portion of the paper roll holder may be inserted through the aperture and held in an interference fit with the bracing material.

The material dispensing system may also comprise a hanging member having a proximal end rotatably connected to the material dispenser, and a distal end including a retaining element, wherein the retaining element is rotatable through an angle of at least about 90 degrees.

The hanging member may be rotatably connected to the material dispenser with a ball and socket joint, where the ball and socket joint has a locking feature to lock the at least one hanging member in a hanging position.

### BRIEF DESCRIPTION OF THE DRAWINGS

The above aspects and other features, aspects, and advantages of the present invention will become better understood with regard to the following description, appended claims, and accompanying drawings in which:

FIG. 1 is a perspective view illustrating the material dispenser hanging from a dry paper roll holder.

FIG. 2 is a front view illustrating the material dispenser from FIG. 1.

FIG. 3 is a perspective view illustrating the material dispenser hanging from another portion of a dry paper roll holder.

FIG. 4 is a side view illustrating the hanging member in the extended position.

FIG. 5 is a side view illustrating the hanging member in the retracted position.

FIG. 6 is a bottom view illustrating the bottom of an exemplary material dispenser.

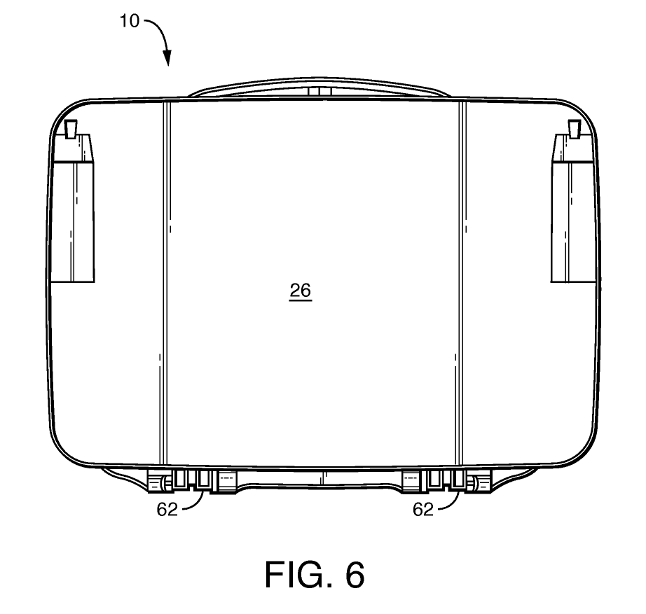

FIG. 7 is a perspective view illustrating the exemplary base for use with the material dispenser.

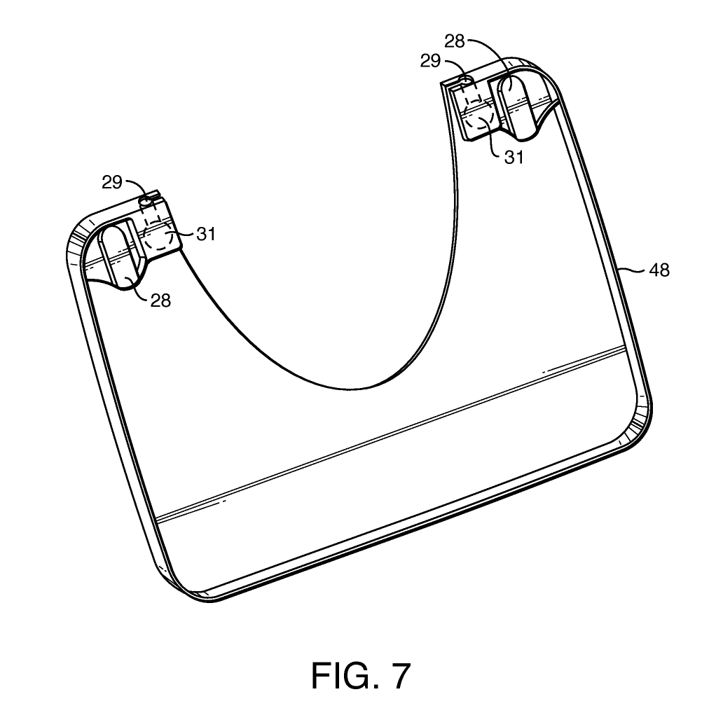

FIG. 8 is a bottom view illustrating the bottom of the material dispenser and a base storing a pair of hanging members within a cavity.

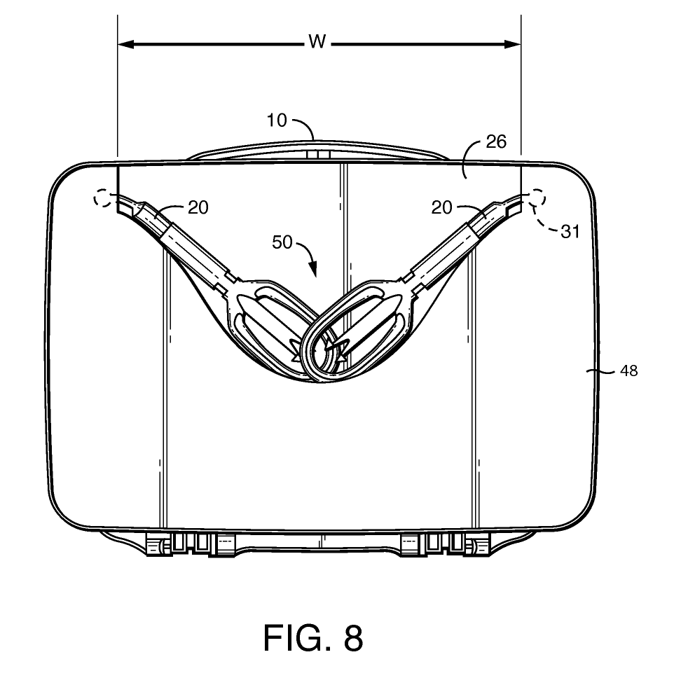

Repeated use of reference characters in the specification and drawings is intended to represent the same or analogous features or elements of the invention in different embodiments.

### DETAILED DESCRIPTION

It is to be understood by one of ordinary skill in the art that the present discussion is a description of exemplary embodiments only, and is not intended as limiting the broader aspects of the present invention, which broader aspects are embodied in the exemplary construction.

Generally, a material dispensing system for hanging from a support is disclosed. The material dispenser 10 can be hung beneath a support structure by at least one hanging member 20. For example, the at least one hanging member 20 may be connected from the middle of a material dispenser 10. Desirably, a pair of hanging members 20, such as a right-hand and a left-hand hanging member attached to the material dispenser and extending from both sides of the material dispenser 10, may be used to support the material dispenser 10. Desirably, the support is a paper roll holder for supporting a paper roll, such as a bath tissue or paper towel roll.

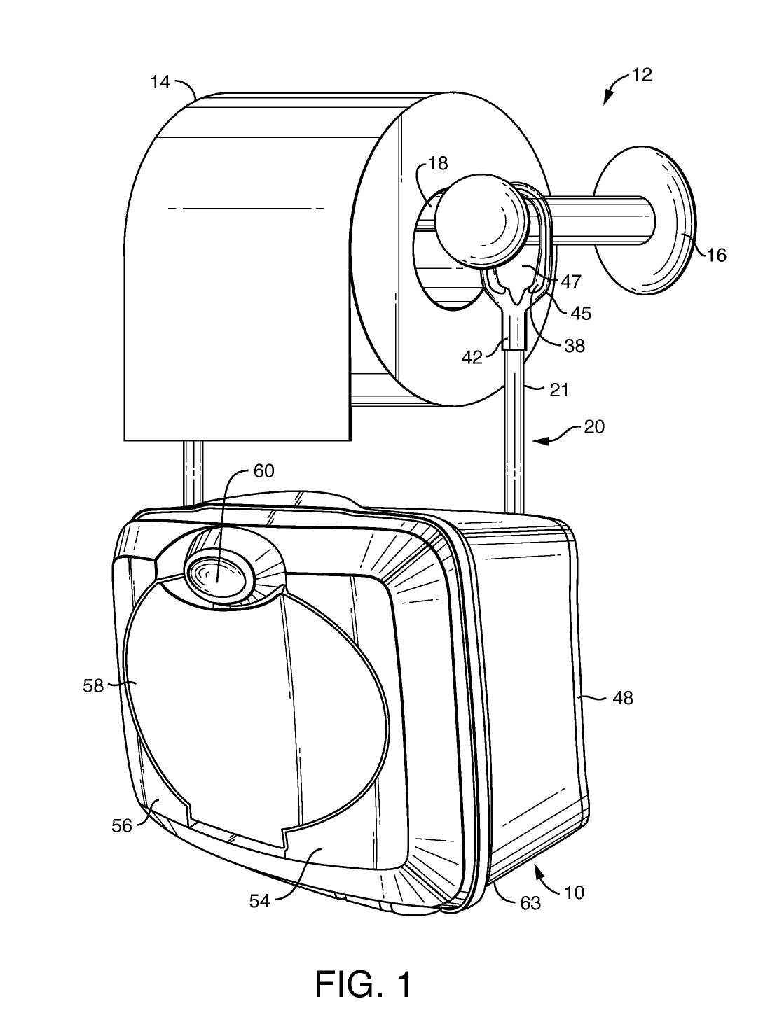

Referring now to FIGS. 1-5, an exemplary material dispensing system 10 is illustrated. A material dispenser 10 may be hung from a portion of a paper roll holder 12 supporting a paper roll 14. The paper roll holder 12 includes at least one support structure 16, but most often includes a pair of support structures 16 and a removable spindle 18. Various paper roll holders exist and they may be recessed partially into a wall, an integral assembly having a backing plate for mounting on a wall or other surface, separate posts as shown, or otherwise vary from the paper roll holder 12 illustrated in FIG. 1. As used herein, the support structures 16 of the paper roll holder 12 comprise the structure surrounding an aperture that the spindle 18 is inserted into and supported by, the structure typically extending some distance away from the surface to which the paper roll holder is mounted. The support structures 16 may be round, rectangular, arcuate or other cross-sectional shapes. The paper roll holder 12 may also include support structures 16 may have a projection or stub shaft that is inserted into the core of the paper roll 14 thereby eliminating the spindle 18. Alternatively, the hanging member 20 may also be attached to other structures other than paper roll holders such as towel racks.

The hanging member 20 can be provided with a retaining element 45 for removably attaching the hanging member 20 to at least one support structure 16 or spindle 18 of the paper roll holder 12. As illustrated in the figures, the retaining element 45 defines an aperture 47 in the distal end of the hanging member 20 allowing insertion of the paper roll holder's support structures 16 or spindle 18 to hang and support the material dispenser 10. Alternative retaining elements for removably attaching the hanging members 20 to at least one support structure 16 of a paper roll holder 12 can include, for example, hooks located on the hanging member 20, adjustable loops located on the hanging member 20, tying the hanging member 20 to the paper roll holder 12 by using a cord or string, or adhesively attaching the hanging member 20 to the paper roll holder 12 with non-permanent adhesive.

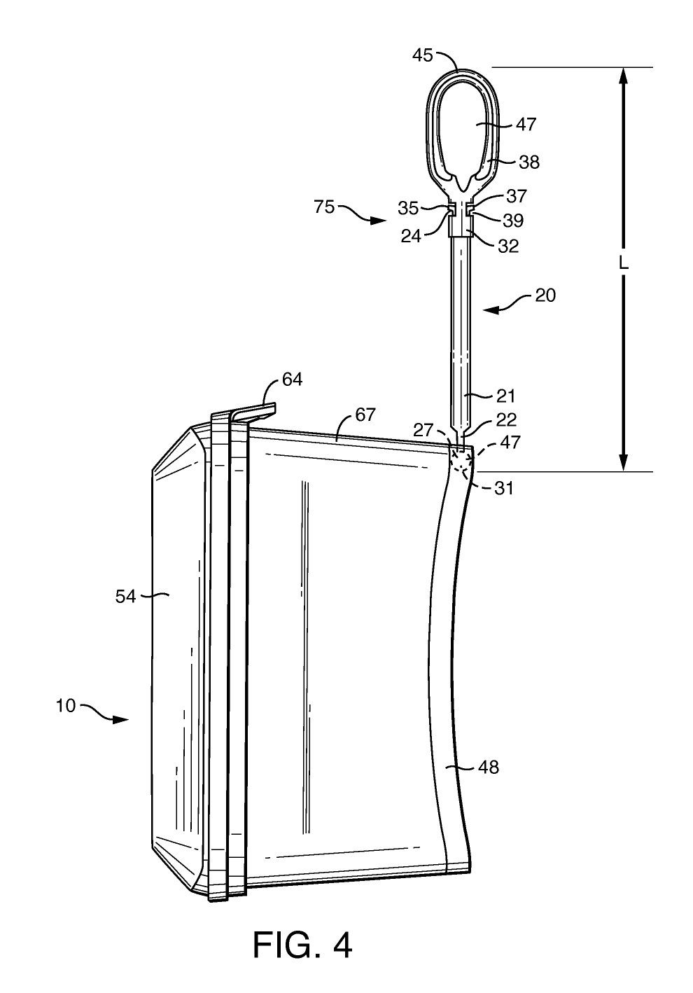

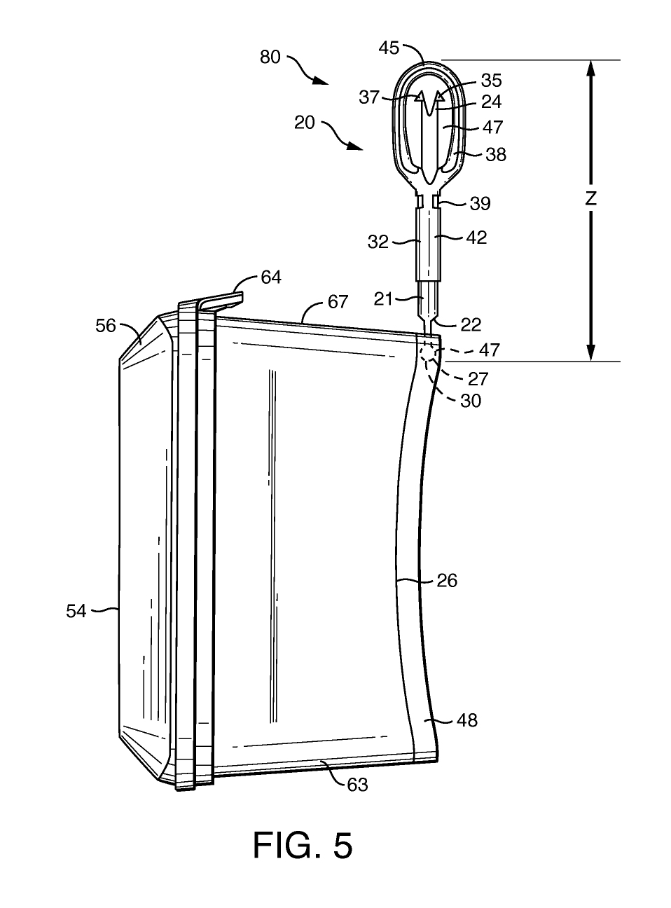

Referring now to the specific embodiments illustrated in FIGS. 4 and 5, more details of exemplary hanging members 20 are shown. Each hanging member 20 may include an arm 21 having a proximal end 22 attachable to the material dispenser's bottom 26 and a distal end 24. Located on the distal end 24 of the arm 21 is the retaining element 45.

Exemplary hanging members 20 may further comprise an extension member 42 slidably mounted on the arm 21. The extension member 42 includes the retaining element 45 formed on its distal end to accommodate a portion of the paper roll holder for hanging and supporting the material dispenser 10. As discussed above, the retaining element 45 may define an aperture 47 in the distal end of the extension member 42 for insertion of the spindle 18 or support structures 16 of the paper roll holder for supporting the material dispenser 10.

The retaining element 45 may further contain a bracing material 38 on the inner portion of the retaining element 45. The bracing material 38 is designed to contact a portion of the paper roll holder 12 and acts as a stabilizer to help minimize the movement inherent in a hanging dispenser that doesn't contact the wall. As illustrated in the Figures, the retaining element 45 may define an aperture 47 in the distal end of extension member 32 that includes a bracing material 38 at least partially filling the aperture 47. When hanging from the paper roll holder, the support structure 16 or the spindle 18 of the paper roll holder 12 is inserted through the aperture and may be in an interference fit with the bracing material 38.

The bracing material 38 of the retaining element 45 can be made of a suitable material having the ability to be pliable enough to fit around a paper roll holder and partially conform to the paper roll holder to help prevent movement of the retaining element relative to the paper roll holder. Materials which can be employed as the bracing material include, but are not limited to, any of the family of styrenic-based thermoplastic elastomeric (i.e. styrenic block copolymer compounds); styrenic-based thermoplastic elastomeric containing rubber modifiers such as Kraton®, Santoprene®, or other rubber modifiers; Kraton®; Santoprene®; specialty copolymers, such as ethylene-methyl acrylate copolymers (e.g. EMAC® of the Eastman Chemical Company); thermoset rubbers; polyurethane; alloys; amides; engineering thermoplastic elastomers; olefinic-based; olefinic vulcanizates; polyester-based; polyurethane-based. One suitable elastomeric material is a thermoplastic elastomer stryrenic block copolymer compound known as DYNAFLEX G translucent series G6730, produced by GLS Corporation, having an office in McHenry, Ill. Such a material has a percent elongation as measured by ASTM method D412, Die C of 530%, a 100% Modulus as measured by ASTM method D412, Die C of 110 psi, a hardness of 30 Shore A as measured by ASTM method D2240, 10 second delay, a coefficient of friction (COF) of 2.3 as measured by ASTM method D1894, and a tear strength as measured by ASTM method D142, Die C of 80 pli. Desirably, the thermoplastic elastomer material has a value for the 100% modulus that is less than the value for its elongation percent; more desirably the thermoplastic elastomer material has a value for the 100% modulus that is less than ½ the value for its elongation percent to improve its stretchiness. Desirably, the thermoplastic elastomer material has high tear strength to prevent ripping while under tension such as from about 40 pli to about 300 pli. Other suitable elastomeric materials can include EPDM rubber, silicones, and polyurethanes.

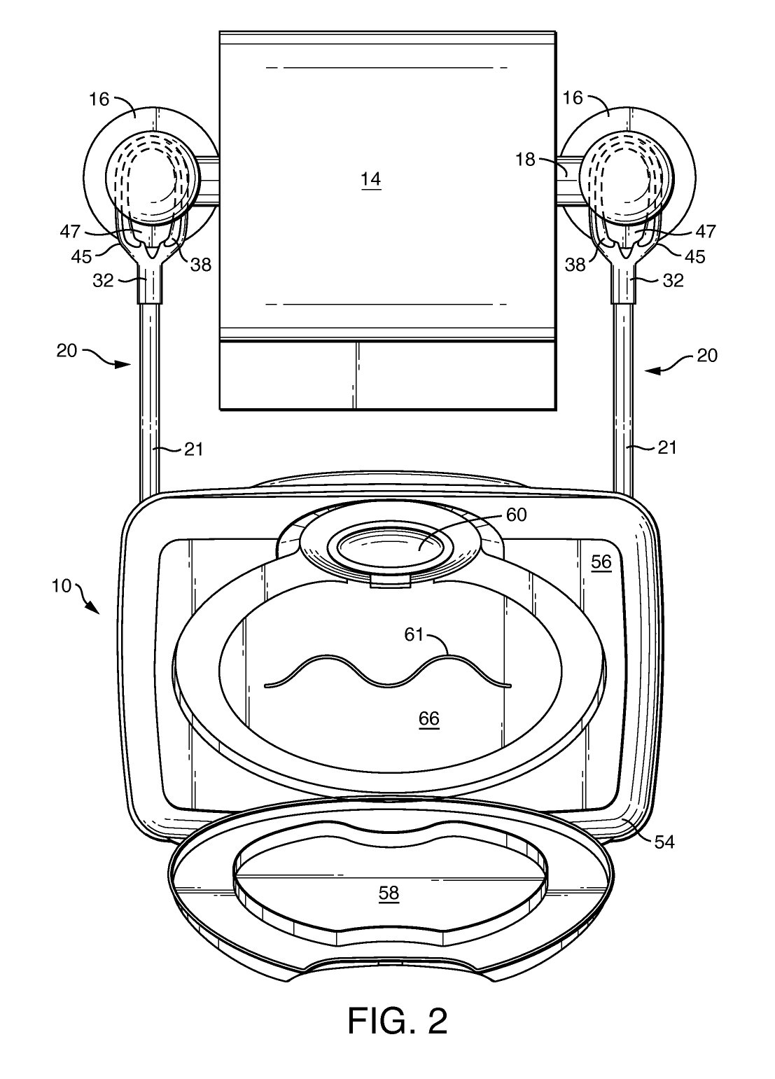

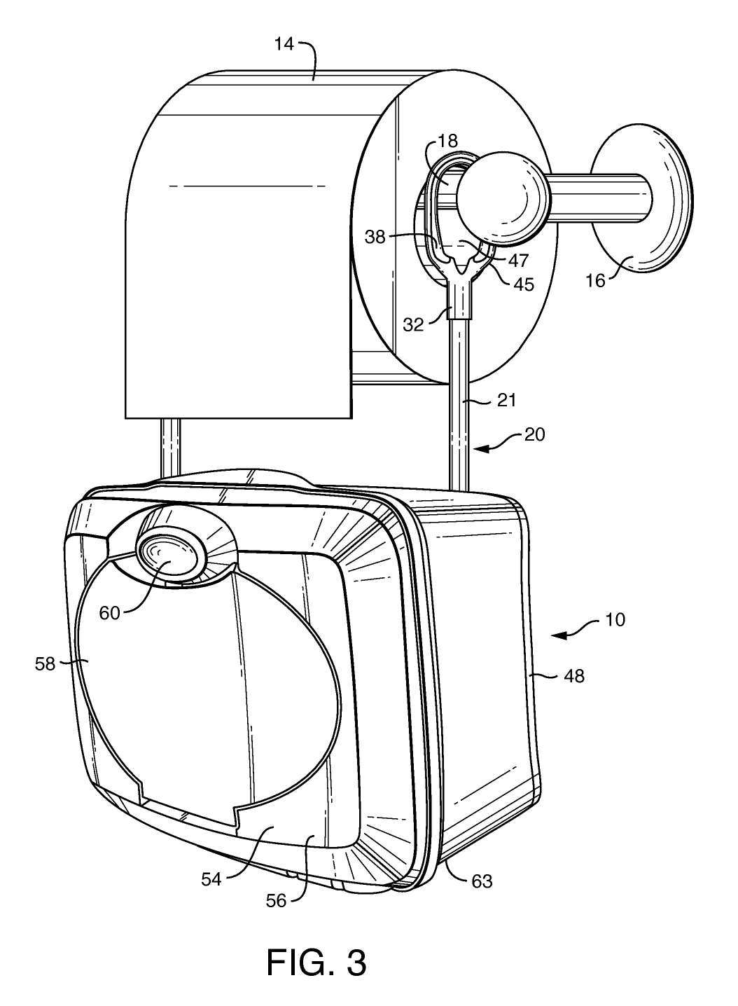

To allow the retaining element 45 to accommodate either the spindle 18 or the support structure 16 of the paper roll holder 12, the hanging member may include a rotatable attachment 27 to the material dispenser 10. For example, a mating ball and socket joint 31 on the dispenser to provide a pivot point for the arm 21 may be used. The rotatable attachment 27 allows the hanging member 20 to be axially rotatable through an angle of at least 90 degrees so that the retaining element 45 may accommodate either the spindle 18 or support structures 16 of the paper roll holder. For example, as illustrated in FIGS. 1 and 2, a user may rotate the hanging member 20 about the axis of the hanging member 20 so that the retaining element 45 is in a forward-facing position and engage the support structure of the paper roll holder. Alternatively, as illustrated in FIG. 3, a user may rotate the hanging member 20 the axis of the hanging member 20 at an angle of 90 degrees from the forward-facing position so that the retaining element 45 is in a side-facing position and engages the spindle of the paper roll holder.

Additionally, the rotatable attachment 27 can provide a pivot point, such that when not in use, the hanging member 20 can be folded out of the way and placed into storage. For example, the hanging member 20 may be folded at the pivot point underneath the material dispenser 10 and stored within a cavity 50 defined by a base on the bottom 23 of the material dispenser 10. Thus, as shown in the Figures, the hanging member 20 can be folded out of the way in a storage position or extended outward from the dispenser in a hanging position.

The base 48 may be an integral part of the bottom 26 of the material dispenser 10 or a separate piece attached to the bottom 26 of the material dispenser 10. For example, the base 48 can be formed into the material dispenser's bottom 26. The base 48 can define a cavity 50 having a width, W, in which the hanging members can rest or snap into.

A base 48 that may be removably attached to the bottom of the material dispenser 10 can also be used. For example, a slot 34 can extend into the material dispenser's interior such as a vertical slot extending towards the material dispenser's top that is located in the bottom of the material dispenser 10 for engaging a tongue 28 extending from the base. The base could also include a flange that engages with the material dispenser's bottom and sidewall to removably attach the base underneath the material dispenser. Alternatively, the base can be attached with hook and loop material, non-permanent adhesive materials such as 3M Command® adhesive strips, mechanical fasteners such as screws, by using pins and apertures, or by a light press fit. Thus, the base can be provided with a means for removably attaching the base 48 to a material dispenser 10 as discussed above and illustrated in the Figures. Additionally, the base 48 can be sold as a kit with the material dispenser 10 and can include a pair of hanging members 20 such as a right-hand and a left-hand hanging member that are initially not attached to the material dispenser 10.

The material dispenser 10 can be used either with the base 48 attached or with the base 48 removed such that the material dispenser's bottom 26 rests on the counter. The material dispenser 10 may also rest on a counter with the base 48 attached. Typically, the base 48 will be attached to the material dispenser 10 when sold and then remain on the material dispenser 10 whether the user hangs the material dispenser or uses the material dispenser on a counter. The base's bottom 26 or a portion thereof such as a ¼ inch wide strip around the perimeter of the bottom can be an anti-slip, foam, or elastomeric material to reduce movement of the material dispenser on surfaces or to reduce any impact of the material dispenser with a wall when hanging.

To maintain the hanging member 20 in the hanging position, the rotatable attachment 27 can include a locking feature 29 adjacent the mating ball and joint socket 31 that prevents the hanging member 20 from rotating away from the hanging position. As shown in the Figures, the locking feature 29 may be a locking catch for the arm 21 to lock into and help to prevent unwanted rotation of the hanging member 20. Other locking features known to those skilled in the art may be used to hold the hanging member 20 in place.

As described above, the hanging member 20 may also include an extension member 32 slidably mounted on the arm 21. The extension member 32 is adapted to slide along the arm 21 of the hanging member 20 to provide an extended position 75 or a retracted position 80. As illustrated in the Figures, the extension member 32 may be in a telescoping relationship with the arm 21 of the hanging member 20 to allow sliding of the extension member 32. Other means of slidably mounting the hanging 20 member may also be used.

In the exemplary embodiment, to extend the hanging member 20, the extension member 32 is pulled outward so that a proximal end 41 of the extension member 32 is in communication with a distal end 24 of the arm 21. The distal end 24 of the arm 21 may include a locking feature 35 that prevents the extension member 32 from being removed from the arm 21 and maintains the extension member 32 in the extended position 75 for hanging the material dispenser. As illustrated in FIGS. 4 and 5, the locking feature may include a latch 39 that engages a catch 37 in the distal end of the extension member 32.

When the extension member 32 is extended along the arm into an extended position 75, the hanging member 20 is sufficiently long from the proximal end 22 to the distal end 24 of the arm and attached to the material dispenser in such a manner that the material dispenser 10 will not interfere with a large diameter paper roll 14. Desirably, a clearance of about 2.5 cm or greater is provided between the material dispenser's sidewall 67 and a full size paper roll's lower surface. A full size toilet paper roll typically has a radius of about 7.5 cm to about 10 cm. Thus, when in the extended position, the hanging member 20 should extend outward so that the retaining element has an extended length, L, of at least about 10 cm above the sidewall 67 of the material dispenser 10 to ensure that the material dispenser 10 does not touch a typical toilet paper roll. Other diameter paper rolls, such as paper towels or shop towels may require a different distance depending on the roll's diameter when first placed into the paper roll holder 12.

When the hanging member 20 is retracted into a retracted position 80, the hanging member 20 defines a compact length, Z. The compact length, Z, is sufficiently compact such that the hanging member may be stored within a cavity 50 defined by a base on the bottom 23 of the material dispenser 10. Thus, the compact length, Z, is less than a width, W, of the cavity 50 to allow the hanging member to be stored within the cavity.

Material for use with the material dispenser disclosed herein is typically a flexible substrate, which is useful for household chores, cleaning, personal care, health care, food wrapping, and cosmetic application or removal. Non-limiting examples of suitable substrates for use with the material dispenser include nonwoven substrates; woven substrates; hydro-entangled substrates; air-entangled substrates; paper substrates comprising cellulose such as tissue paper, toilet paper, or paper towels; waxed paper substrates; coform substrates comprising cellulose fibers and polymer fibers; wet substrates such as wet wipes, moist cleaning wipes, moist toilet paper wipes, and baby wipes; film or plastic substrates such as those used to wrap food; shop towels; and metal substrates such as aluminum foil. Furthermore, laminated or plied together substrates of two or more layers of any of the preceding substrates are also suitable.

Typically, the substrates are either wet or pre-moistened by an appropriate liquid, partially moistened by an appropriate liquid, or the substrates are initially dry but intended to be moistened prior to use by placing the substrate into an appropriate liquid such as water or a solvent. Non-limiting examples of suitable wet substrates include a substantially dry substrate (less than 10% by weight of water) containing lathering surfactants and conditioning agents either impregnated into or applied to the substrate such that wetting of the substrate with water prior to use yields a personal cleansing product.

The hanging member 20 can be used with many different kinds of material dispensers 10, but desirably the material dispenser is designed to house a plurality of individual sheets that are pre-moistened with a cleansing solution to function as wet wipes. Referring now to the Figures, the material dispenser 10 can include a top 54, the bottom 26, and the sidewall 67. Desirably, the top 54 includes a main-lid 56, a mini-lid 58, a push button 60, and a dispensing orifice 61. The sidewall 67 and the bottom 26 form a lower tub 63 of the material dispenser 10. The main-lid 56 can be hingably attached to the sidewall 67 by a pair of hinges 62. The main-lid 56 is secured in the closed position by a latch 64. When the latch 64 is unfastened, the main-lid 56 can be opened to expose the entire top of the tub 63 to replenish the material dispenser 10 with new wet wipes. The material dispenser 10 can be refilled without having to remove the material dispenser 10 from the paper roll holder 12 since the main-lid 56 is hinged away from the paper roll 14 and rotates downward or away from the paper roll 14, improving access to the material dispenser's interior. Alternatively, the material dispenser 10 can be removed from the base 48 to refill the material dispenser 10 while leaving the base 48 attached to the paper roll holder 12, or the entire assembly can be removed from the paper roll holder 12.

To dispense a wet wipe from the material dispenser 10, the push button 60 is depressed and a biasing spring rotates the mini-lid 58 to an open position, thereby exposing an exposed portion of the wet wipe. The rear edge of the mini-lid 58 can includes a pair of posts or projections that mate with a pair of apertures in the main-lid 56 for rotational movement. Desirably, the sheets forming the wet wipes are folded, perforated, interfolded, or interrelated such that withdrawing one wipe partially withdraws a portion of the next sheet. Desirably, the mini-lid 58 rotates downward or away from the paper roll 14, such that the exposed portion of the wet wipe is above the mini-lid 58 when the mini-lid is in the open position with the material dispenser 10 hanging from the paper roll holder 12 as best seen in FIG. 2. By having the mini-lid 58 rotate down and away from the main-lid 56, it is less likely to interfere with drawing the wet wipe and makes it easier to find and grab the exposed portion of the wet wipe.

The material dispenser 10 can be co-molded from two different materials such as a hard plastic and a softer thermoplastic elastomer material. As such, sealing areas between the main-lid 56 and tub 63, and/or between the mini-lid 58 and main-lid 56 can have a gasket formed by the thermoplastic elastomer material, if desired, to enhance moisture retention of the material dispenser 10. The arm 21 can also be co-molded with the body portion. The push button 60 can be co-molded with the sides of the push button formed from thermoplastic elastomer material for easier use.

The dispensing orifice 61 can be formed as a slit in a dispensing panel 66 located beneath the mini-lid 58 that is formed from flexible or elastic material. The narrow slit in the dispensing panel 66 can help to retain moisture in the material dispenser 10, securely hold the exposed portion of the wet wipe in place and make it easier to reach into the material dispenser to retrieve the next wipe should the pop-up functionality fail since the elastomeric or flexible material can be readily deformed and then spring back into shape.

The dispensing panel 66 can be a flexible rubber-like sheet, the relevant material properties can be described in terms of the hardness, stiffness, thickness, elasticity, specific gravity, compression set, and any combination thereof. More specifically, the Shore A hardness (as measured by ASTM D2240) of the flexible, rubber-like sheet or material can be about 100 or less, more specifically from about 20 to about 90, and still more specifically from about 40 to about 80, and yet more specifically from about 60 to about 70 Shore A. The Gurley stiffness of the flexible, rubber-like sheet or material (as measured by ASTM D6125-97 “Standard Test Method for Bending Resistance of Paper and Paperboard”) can be about 10,000 milligrams of force (mgf) or less, more specifically from about 100 to about 8000 mgf, more specifically from about 200 to about 6500 mgf, and still more specifically from about 300 to about 1500 mgf. The thickness of the flexible, rubber-like sheet can be about 10 mil or greater, more specifically from about 10 mil to about 110 mil, and still more specifically from about 35 mil to about 60 mil. The elasticity of the flexible rubber-like material or sheet, as characterized by the tensile stress at 100 percent elongation and measured in accordance with ASTM D412 “Standard Test Methods for Vulcanized Rubber and Thermoplastic Elastomers”, can be about 10 megapascals (MPa) or less, more specifically from about 0.1 to about 7 MPa, and still more specifically from about 0.5 to about 2.5 MPa. The flexible rubber-like sheet can have a specific gravity (per ASTM D792) of about 0.80 to 1.21, more specifically 0.88 to about 1.10, and still more specifically from about 0.90 to about 1.0. The flexible rubber-like sheet can have a compression set (per ASTM 395B) of (at room temperature/at 70° F.) about 8/30 to 40/120 and more specifically 15/45 to about 28/100. One such material for the flexible dispensing panel could be that manufactured by the GLS-Corporation of McHenry, Ill. and known as resin #G2701. The G2701 material is one of the resins in the product family of TPEs. G2701 is a styrenic-based material and is in the family of Styrenic block copolymer compounds. Some particular properties of the G2701 can be: specific gravity of 0.090 g/cc (per ASTM D792); hardness (Shore A durometer) of 68 (ASTM D2240); and compression set of 24% at room temperature, 96% at 70° F. (per ASTM 395B). Another similar material is known as G2755 and also sold by GLS Corporation. In addition, a lubricant (e.g., wax) can be added to lower the coefficient of friction of the continuous slit which can benefit injection molding, wet wipes dispensing, and physical handling of the flexible orifice. The G2701 TPE resin with ¼% wax additive sold by GLS Corporation and known as #LC217-189 can be used.

The hanging member 20 in the preceding embodiments has been shown in combination with a material dispenser 10 and intended for wet wipes and co-located beneath a dry toilet paper roll. However, the material dispenser 10 and the arm 21 can be used in combination with a paper towel holder for kitchen applications. Attachment to other paper roll holders is also contemplated such as holders for shop towels. Alternatively, the material dispenser 10 can be used with another material instead of wet wipes, or the arm 21 can be used to support an auxiliary dry paper roll by attaching two arms to a second spindle.

Other modifications and variations to the present invention may be practiced by those of ordinary skill in the art without departing from the spirit and scope of the present invention, which is more particularly set forth in the appended claims. It is understood that aspects of the various embodiments may be interchanged in whole or part. The preceding description, given by way of example in order to enable one of ordinary skill in the art to practice the claimed invention, is not to be construed as limiting the scope of the invention, which is defined by the claims and all equivalents thereto.

1. A material dispensing system for hanging from a support comprising:
a material dispenser; and
at least one hanging member comprising:
an arm having a proximal end rotatably connected to the material dispenser,
an extension member slidably mounted on the arm and adapted to slide between an extended position and a retracted position, the extension member having a distal end including a retaining element;
wherein the arm has a first length in the extended position and a second length in the retracted position, and the first length is longer than the second length; and.

2. The material dispensing system of claim 1 wherein the retaining element defines an aperture.

3. The material dispensing system of claim 1 wherein the retaining element is selected from a loop, an adhesive and a hook.

4. The material dispensing system of claim 1 wherein the retaining element further comprises a bracing material on a support-facing side of the retaining element, the bracing material comprising a thermoplastic elastomer.

5. The material dispensing system of claim 1 wherein the retaining element defines an aperture and comprises a bracing material extending toward the aperture, wherein a portion of the support is inserted through the aperture and is in an interference fit with the bracing material.

6. The material dispensing system of claim 1 wherein the distal end of the arm includes a locking feature to lock the extension member in the extended position.

7. The material dispensing system of claim 1 wherein the hanging member in the extended position has a length of at least 10 cm.

8. The material dispensing system of claim 1 wherein the arm is rotatably connected to the material dispenser with a ball and socket joint.

9. The material dispensing system of claim 8 wherein the ball and socket joint has a locking feature to lock the at least one hanging member in a hanging position.

10. The material dispensing system of claim 1 wherein the retaining element is rotatable through an angle of at least about 90 degrees wherein the arm is rotatably connected to the material dispenser with a ball and socket joint.

11. The material dispensing system of claim 1 wherein the proximal end is also pivotally connected to the material dispenser.

12. The material dispensing system of claim 11 wherein the material dispenser comprises a base defining a cavity and the at least one hanging member is rotatable into the cavity for storage.

13. The material dispensing system of claim 12 wherein the at least one hanging member defines a compact length with the extension member in the retracted position, and a width of the cavity is less than the compact length.

14. The material dispensing system of claim 12 wherein the base is an integral part of the material dispenser.

15. The material dispensing system of claim 14 wherein the base is removably attached to the material dispenser.

16. A material dispensing system for hanging from a support comprising:
a material dispenser; and
at least one hanging member having:
a proximal end rotatably connected to the material dispenser, and
a distal end including a retaining element, wherein the retaining element is rotatable through an angle of at least about 90 degrees;
wherein the arm is rotatably connected to the material dispenser with a ball and socket joint.

17. (canceled)

18. The material dispensing system of claim 16 wherein the at least one hanging member comprises:
an arm having a proximal end rotatably connected to the material dispenser,
and an extension member slidably mounted on the arm and adapted to slide between an extended position and a retracted position, the extension member having a distal end including a retaining element.

19. The material dispensing system of claim 16 wherein the retaining element defines an aperture and comprises a bracing material extending toward the aperture, wherein a portion of a paper roll holder is inserted through the aperture and is in an interference fit with the bracing material.
